(19) United States
(12) Patent Application Publication
(10) Pub. No.: US 2014/0284356 A1
(43) Pub. Date: Sep. 25, 2014

(54) Reservoir Fluid Automatic Dispenser

(71) Applicant: Hong Ann Tool Industries Co., Ltd., Taichung City (TW)

(72) Inventor: Cheng-Wei Su, Taichung City (TW)

(73) Assignee: Hong Ann Tool Industries Co., Ltd., Taichung City (TW)

(21) Appl. No.: 14/146,033

(22) Filed: Jan. 2, 2014

(30) Foreign Application Priority Data
Mar. 22, 2013 (TW) 102110176

(51) Int. Cl. B05C 17/00

(52) U.S. Cl. CPC B05C 17/002
USPC 222/153.13; 222/386; 222/340

(57) ABSTRACT

A reservoir fluid automatic dispenser includes a reservoir delimiting a space for receiving a fluid, including a top edge delimiting an opening, and including a fluid exit. A dispensing mechanism includes a fixing end to fix with the reservoir, a pushing end to force the liquid out of the reservoir through the fluid exit, and a biasing member to automatically move the pushing end. The biasing member is restrained between the fixing end and the pushing end. The pushing end is disposed and moving inside the space under a tension of the biasing member.

### BACKGROUND OF THE INVENTION

1. Field of the Invention The present invention relates to reservoir fluid dispenser and, particularly to a reservoir fluid dispenser which dispenses fluid automatically.

2. Description of the Related Art

TW Patent No. M446030 shows a liquid sprayer that a user manually reciprocates a pushing apparatus to increase its internal pressure to force liquid out. The more strokes. of the pushing apparatus, the more increase in the internal pressure of the liquid sprayer, but exceeding internal pressure can damage the liquid sprayer and can be dangerous for the user. Additionally, it is inconvenient for the user to repetitiously reciprocate the pushing apparatus.

The present invention is, therefore, intended to obviate or at least alleviate the problems encountered in the prior art.

### SUMMARY OF THE INVENTION

According to the present invention, a reservoir fluid automatic dispenser includes a reservoir delimiting a space for receiving a fluid, including a top edge delimiting an opening, and including a fluid exit. A dispensing mechanism includes a fixing end to fix with the reservoir, a pushing end to force the liquid out of the reservoir through the fluid exit, and a biasing member to automatically move the pushing end. The biasing member is restrained between the fixing end and the pushing end. The pushing end is disposed and moving inside the space under a tension of the biasing member.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a reservoir fluid automatic dispenser which dispenses fluid automatically.

It is another object to provide a reservoir fluid automatic dispenser to which a paint apparatus can connect. Therefore, fluid can dispense to the paint apparatus automatically.

Other objects, advantages, and new features of the present invention will become apparent from the following detailed description of the invention when considered in conjunction with the accompanied drawings.

### BRIEF DESCRIPTION OF THE DRAWINGS

FIG. 1 is a perspective view of a reservoir fluid automatic dispenser in accordance with a first embodiment of the present invention and a paint apparatus connected to the reservoir fluid automatic dispenser.

FIG. 2 is an exploded perspective view of the reservoir fluid automatic dispenser and the paint apparatus of FIG. 1.

FIG. 3 is an exploded cross-sectional view of the reservoir fluid automatic dispenser of FIG. 1.

FIG. 4 is a cross-sectional view of the reservoir fluid automatic dispenser and the paint apparatus of FIG. 1, with the reservoir fluid automatic dispenser dispensing fluid to the paint apparatus.

FIG. 5 is a perspective view of a reservoir fluid automatic dispenser in accordance with a second embodiment of the present invention and a paint apparatus connected to the reservoir fluid automatic dispenser.

FIG. 6 is an exploded perspective view of the reservoir fluid automatic dispenser and the paint apparatus of FIG. 5.

FIG. 7 is a cross-sectional view showing the reservoir fluid automatic dispenser of FIG. 5.

FIG. 8 is an enlarged perspective view showing the reservoir fluid automatic dispenser of FIG. 5 including an operable control member.

### DETAILED DESCRIPTION OF THE INVENTION

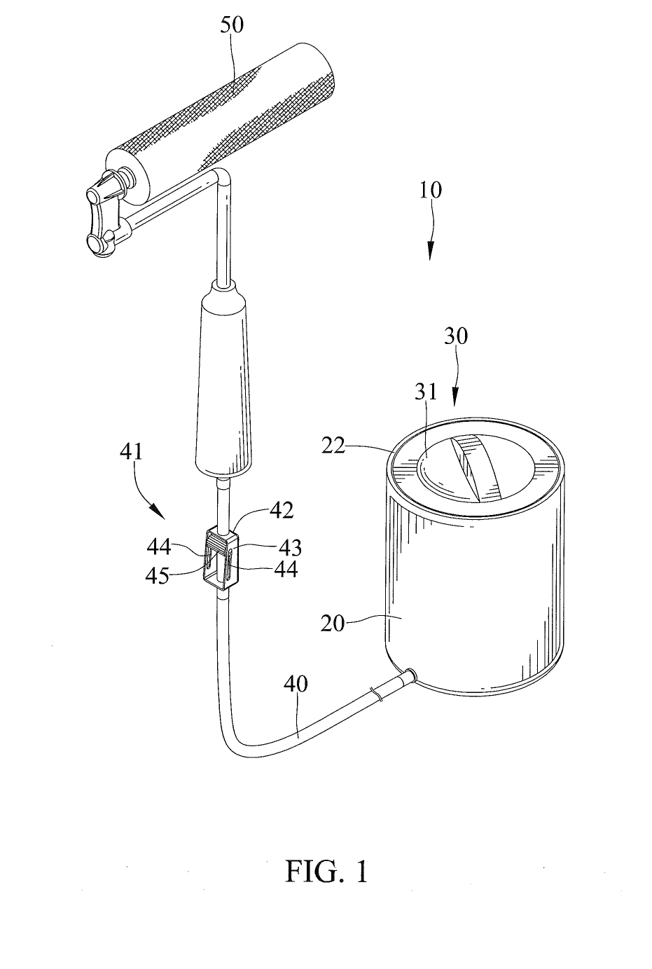

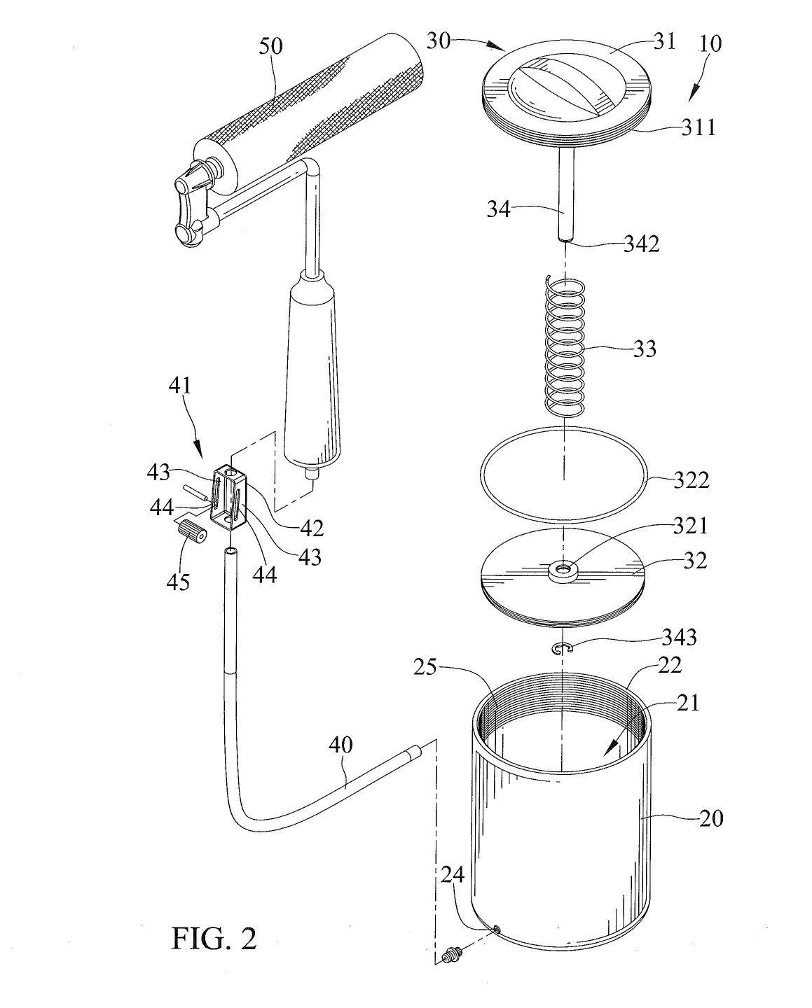

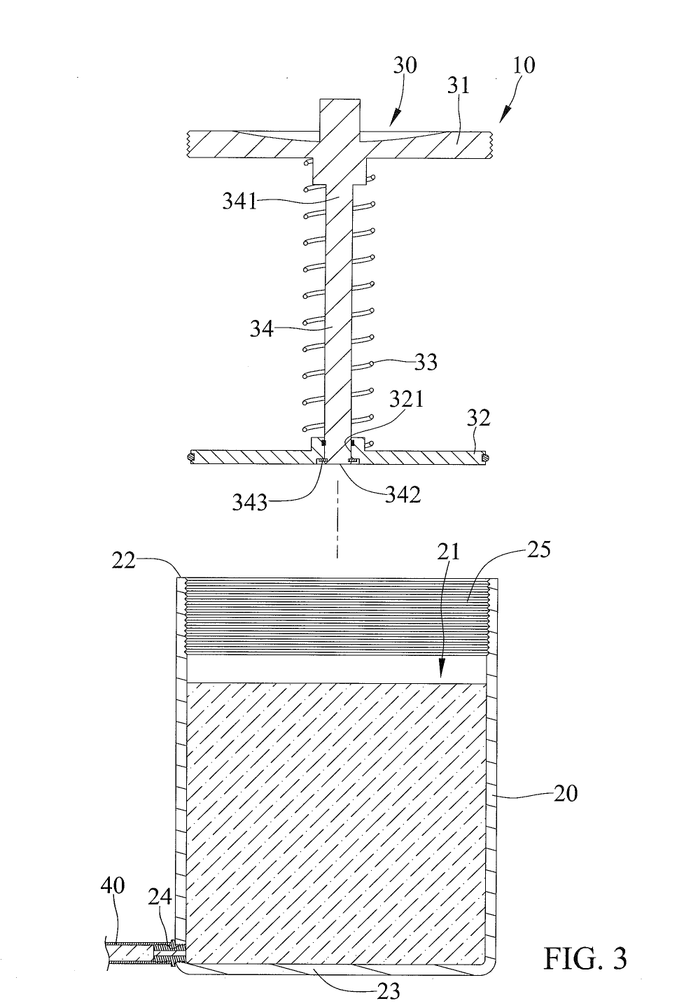

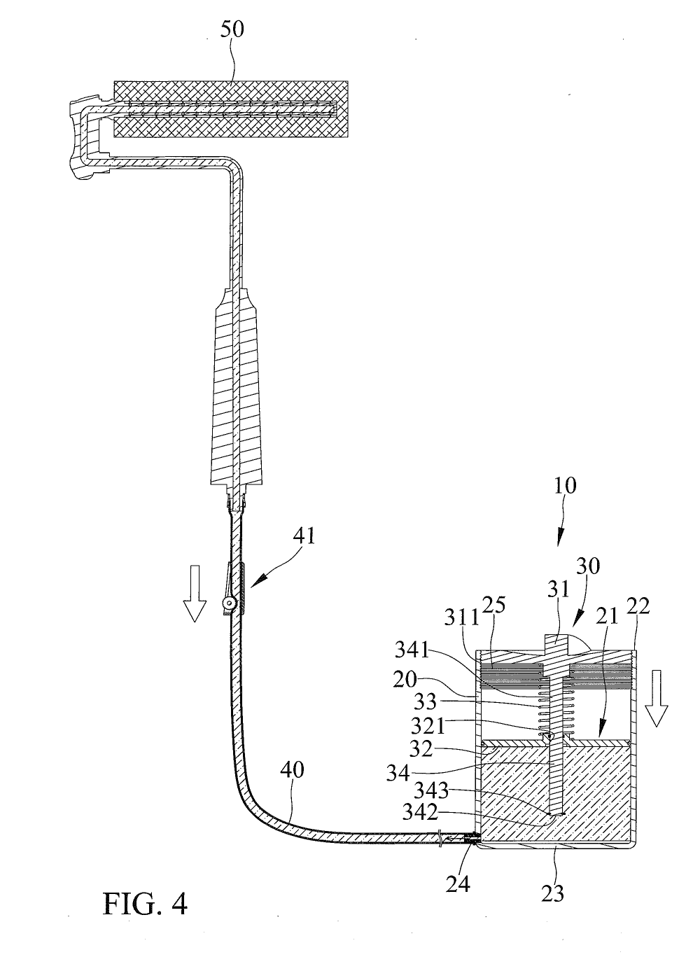

FIGS. 1 through 4 show a reservoir fluid automatic dispenser in accordance with a first embodiment of the present invention. A reservoir fluid automatic dispenser 10 includes a reservoir 20 delimiting a space 21 for receiving a fluid, including a top edge 22 delimiting an opening, and including a fluid exit 24. The reservoir 20 includes a bottom edge 23 and an enclosed circumferential wall on the bottom edge 23, and the fluid exit 24 defines a hole extending through the circumferential wall and disposed adjacent to the bottom edge 23 of the reservoir 20. A dispensing mechanism 30 includes a fixing end 31 to fix with the reservoir 20, a pushing end 32 to force the liquid out of the reservoir 20 through the fluid exit 24, and a biasing member 33 to automatically move the pushing end 32. The fixing end 31 defines a fixing structure engaged with the reservoir 20 and has various height positions to change with respect to the reservoir 20. The fixing end 30 encloses the opening. An inner periphery of the reservoir 20 includes a first thread 25, and the fixing end 31 defines an engaging section 311 including a second thread engaging with the first thread. The first thread has a longer thread length than the second thread. The biasing member 32 is restrained between the fixing end 31 and the pushing end 32. The pushing end 32 is disposed and moves inside the space 21 under a tension of the biasing member 33. Moreover, the dispensing mechanism 30 includes a rod 34 inserting through the biasing member 33 and bearing the pushing end 32. The rod 34 has a first distal end 341 and a second distal end 342 opposite to the first distal end 341, and the first distal end 341 is fixedly disposed on the fixing end 31. The pushing end 32 includes a hole 321 extending therethrough. The rod 34 inserts through the hole 321. Moreover, the dispensing mechanism 30 includes a restrainer 343 restraining the pushing end 32 on the rod 34. The restrainer 343 is disposed on the rod 34, and the pushing end 32 is restrained on the rod 34 by the retainer 343. The retainer 343 is in the form of a ring, but not limiting. The retainer 343 here is a C-ring. The retainer 343 and the biasing member 33 are on different sides of the pushing end 32.

In addition, an external deliver tube 40 joins a paint apparatus 50 to the reservoir fluid automatic dispenser 10, with the external deliver tube 40 having an end fluidly joined to the fluid exit 24 and another end fluidly joined to the paint apparatus 50.

The deliver tube 40 is a soft hose here. The paint apparatus 50 is a paint roller. A regulating device 41 is attached to the deliver tube 40 for adjusting a flow amount of the fluid. The regulating device 41 includes a housing 42 and a controller 45 received by and operably moved with respect to the housing 41. The housing 41 includes two lateral walls 43 and each include a groove 44, and the controller 45 includes two extend ends movably engaged with and the groove 44. The controller 45 has various positions with respect to the housing 41 for different settings.

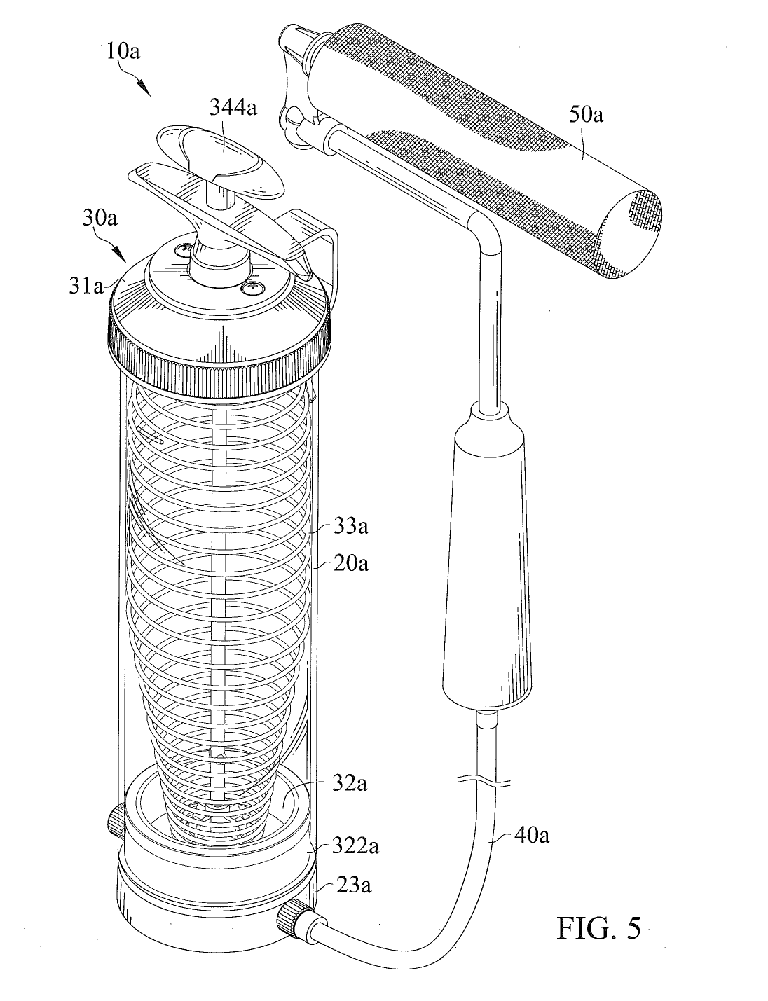

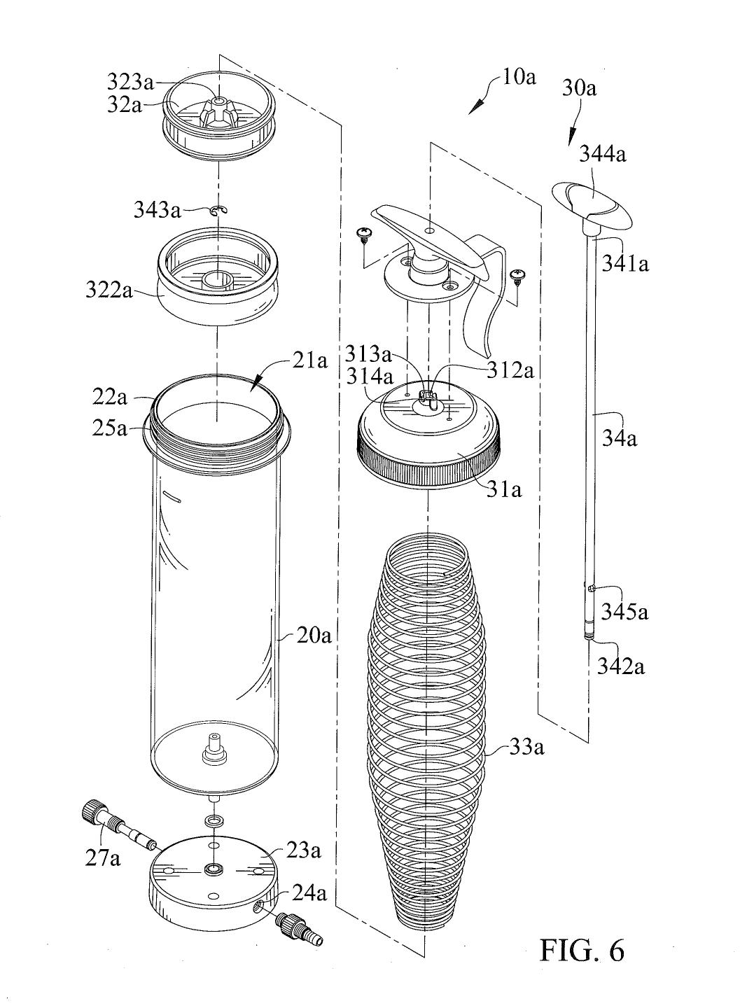

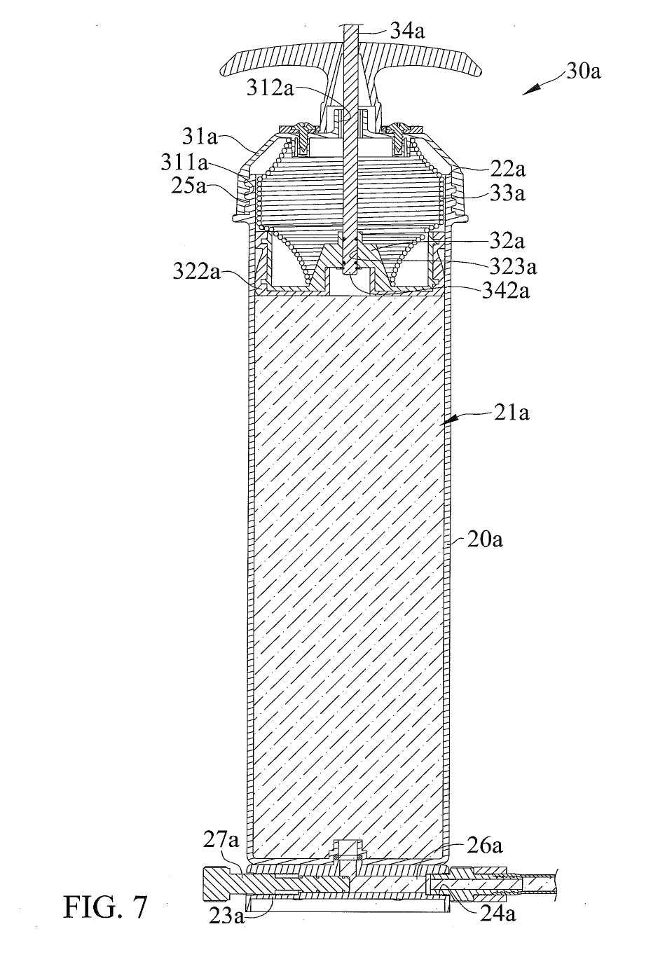

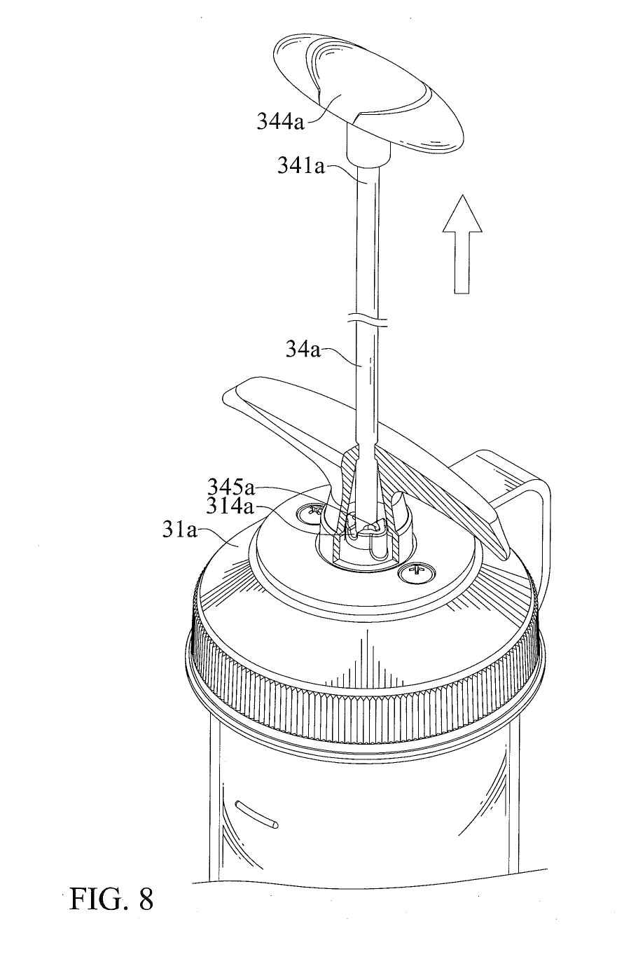

FIGS. 5 through 8 show a reservoir fluid automatic dispenser in accordance with a second embodiment of the present invention, and same numbers are used to correlate similar components of the first embodiment, but bearing a letter a. The second embodiment differentiates from the first embodiment in that a reservoir 20a includes a passage 26a fluidly interconnecting a space 21a and a fluid exit 24a, and includes an adjusting valve 27a received by the passage 26a and having different adjusting positions for changing the size of a gap in the passage 26a.

Further, a fixing end 31a of a dispensing mechanism 30a defines a fixing structure secured to a fixed position of the reservoir 20a. Further, a rod 34a has a first distal end 341a disposed outside the space 21a and a second distal end 342a disposed within the space 21 a respectively, and the second distal end 342a is fixedly disposed on a pushing end 32a. The rod 34a has lock and unlock positions, with the rod 34a in the lock position fixedly engaging with and limited from moving relative to the fixing end 31a, with the rod 34a in the unlock position having a changing length in a space 21a of the reservoir 20a. An outer periphery of the reservoir 20a includes a thread 25a securing the fixing end 31a. Moreover, the rod 34a inserts through a slot 312a extending through the fixing end 31a and includes an outer periphery thereof including at least one protrusion 345a protruding therefrom. The rod 34a in the lock position includes the protrusion 345a restrained by the fixing end 31a, and the rod 34a has an orientation including the protrusion 345a disposed aligned with an enlarged section 311a of the slot 312a in order for the protrusion 345a to pass through the slot 312a. In the embodiment, the protrusion 345a is stably received by at least one recess 314a on the fixing end 31a. Further, a grip 344a is fixed to the first distal end 341a. A user can hold the grip 344a to easily withdraw the rod 34a. The pushing end 32a defines a joining section 323a fixing to the second distal end 342a. The joining section 323a includes a cavity receiving the second distal end 342a.

In view of the forgoing, the reservoir fluid automatic dispenser automatically dispenses fluid to the paint apparatus. The reservoir fluid automatic dispenser saves the user from manually and repetitiously applying pressure to force the fluid out to the paint apparatus.

While the specific embodiments have been illustrated and described, numerous modifications come to mind without significantly departing from the spirit of invention, and the scope of invention is only limited by the scope of accompanying claims.

What is claimed is:

1. A reservoir fluid automatic dispenser comprising:
a reservoir delimiting a space for receiving a fluid, including a top edge delimiting an opening, and including a fluid exit;
a dispensing mechanism including a fixing end to fix with the reservoir, a pushing end to force the fluid out of the reservoir through the fluid exit, and a biasing member to automatically move the pushing end, with the biasing member restrained between the fixing end and the pushing end, with the pushing end disposed and moving inside the space under a tension of the biasing member.

2. The reservoir fluid automatic dispenser as claimed in claim 1, wherein the dispensing mechanism includes a rod inserting through the biasing member and bearing the pushing end.

3. The reservoir fluid automatic dispenser as claimed in claim 2, wherein the fixing end defines a fixing structure engaged with the reservoir and has various height positions to change with respect to the reservoir, wherein the rod has a first distal end and a second distal end opposite to the first distal end, and the first distal end is fixedly disposed on the fixing end.

4. The reservoir fluid automatic dispenser as claimed in claim 2, wherein the fixing end of the dispensing mechanism defines a fixing structure secured to a fixed position of the reservoir, wherein the rod has lock and unlock positions, with the rod in the lock position fixedly engaging with and limited from moving relative to the fixing end, with the rod in the unlock position having a changing length in the space of the reservoir.

5. The reservoir fluid automatic dispenser as claimed in claim 2, wherein the rod has a first distal end disposed outside the space and a second distal end disposed within the space respectively, and the second distal end is fixedly disposed on the pushing end.

6. The reservoir fluid automatic dispenser as claimed in claim 4, wherein the rod inserts through a slot extending through the fixing end and includes an outer periphery thereof including at least one protrusion protruding therefrom, wherein the rod in the lock position includes the protrusion restrained by the fixing end, and the rod has an orientation including the protrusion disposed aligned with an enlarged section of the slot in order for the protrusion to pass through the slot.

7. The reservoir fluid automatic dispenser as claimed in claim 2, wherein the dispensing mechanism includes a restrainer restraining the pushing end on the rod.

8. The reservoir fluid automatic dispenser as claimed in claim 1, wherein the reservoir includes a passage fluidly interconnecting the space and the fluid exit, and includes an adjusting valve received by the passage and having different adjusting positions for changing the size of a gap in the passage.

9. The reservoir fluid automatic dispenser as claimed in claim 1 further comprising an external deliver tube joining a paint apparatus to the reservoir fluid automatic dispenser, with the external deliver tube having an end fluidly joined to the fluid exit and another end fluidly joined to the paint apparatus

10. The reservoir fluid automatic dispenser as claimed in claim 1, wherein the reservoir includes a bottom edge and an enclosed circumferential wall on the bottom edge, and the fluid exit defines a hole extending through the circumferential wall and disposed adjacent to the bottom edge of the reservoir.

11. The reservoir fluid automatic dispenser as claimed in claim 3, wherein an inner periphery of the reservoir includes a first thread, and the fixing end defines an engaging section including a second thread engaging with the first thread, wherein the first thread has a longer thread length than the second thread.

12. The reservoir fluid automatic dispenser as claimed in claim 4, wherein an outer periphery of the reservoir includes a thread securing the fixing end.
